(19) United States
(12) Patent Application Publication
(10) Pub. No.: US 2020/0220195 A1
(43) Pub. Date: Jul. 9, 2020

(54) METHOD OF PRODUCING BATTERY

(71) Applicant: TOYOTA JIDOSHA KABUSHIKI KAISHA, Toyota-shi (JP)

(72) Inventor: Atsushi MURAKAMI, Nisshin-shi (JP)

(73) Assignee: TOYOTA JIDOSHA KABUSHIKI KAISHA, Toyota-shi (JP)

(21) Appl. No.: 16/736,326

(22) Filed: Jan. 7, 2020

(30) Foreign Application Priority Data
Jan. 8, 2019 (JP) 2019-001164

(51) Int. Cl. H01M 10/04; H01M 10/44; H01M 10/0525

(52) U.S. Cl. CPC H01M 10/04; H01M 10/0525; H01M 10/446

(57) ABSTRACT

A first battery including an electrolyte solution is prepared. The first battery has air bubbles between electrodes. Vibration is applied to the first battery, and thereby a second battery is produced. The vibration has a frequency ranging from 25 Hz to 45 Hz.

This nonprovisional application claims priority to Japanese Patent Application No. 2019-001164 filed on Jan. 8, 2019, with the Japan Patent Office, the entire contents of which are hereby incorporated by reference.

### BACKGROUND

### Field

The present disclosure relates to a method of producing a battery.

### Description of the Background Art

Japanese Patent Laying-Open No. 2014-238946 discloses optimization of charge and discharge conditions in an initial charge and discharge (aging) step prior to a gas release step.

### SUMMARY

In the gap between electrodes, air bubbles may sometimes be trapped. The air bubbles may be generated while the battery is under initial charge and discharge, and/or while the battery is left in a high-temperature environment, and/or while the battery is in actual use, for example. It is difficult to detect the presence of the air bubbles by a capacity test, a resistance test, and/or a voltage test, for example. The air bubbles tend not to disappear naturally, and therefore they tend to remain trapped between the electrodes for a long time. The remaining air bubbles may cause various problems. In a lithium-ion battery, for example, they tend to cause lithium (Li) deposition on the peripheries of the air bubbles.

An object of the present disclosure is to remove air bubbles generated between electrodes.

In the following, the technical structure and the effects according to the present disclosure are described. It should be noted that the action mechanism according to the present disclosure includes presumption. Therefore, the scope of claims should not be limited by whether or not the action mechanism is correct.

[1] A method of producing a battery according to the present disclosure includes (A) and (B) described below:

(A) preparing a first battery including an electrolyte solution, the first battery having air bubbles between electrodes; and

(B) applying vibration to the first battery to produce a second battery, the vibration having a frequency ranging from 25 Hz to 45 Hz.

In the method of producing a battery according to the present disclosure, a first battery having air bubbles between electrodes is prepared. The first battery may be a new battery (an unused battery) or may be a spent battery (a used battery). Applying a specific vibration to the first battery may be capable of gradually moving the air bubbles trapped between electrodes and removing them from the gap between electrodes. As a result of the removal of the air bubbles from the gap between electrodes, a second battery is produced.

The second battery is regarded as a new product that is not the same as the first battery. For instance, the second battery may have an enhanced Li-deposition resistance compared to the first battery. The Li-deposition resistance according to the present disclosure refers to a property that does not allow Li deposition to readily occur thereon during high-load charge.

When multiple air bubbles are trapped between electrodes, it is not necessary that all the air bubbles be removed as long as at least one of the air bubbles is removed.

The vibration has a frequency ranging from 25 Hz to 45 Hz. A frequency lower than 25 Hz may still be capable of moving the air bubbles, but moving the air bubbles with this frequency may take a long time and therefore may be regarded as poor economy. When the frequency is higher than 45 Hz, a component included in the battery may be damaged.

[2] For instance, the air bubbles may be generated during initial charge and discharge of the first battery. When the first battery after initial charge and discharge is applied with the vibration, the air bubbles generated during initial charge and discharge may be removed from the gap between electrodes.

[3] For instance, the air bubbles may be generated as a result of the first battery being left in a high-temperature environment. When the first battery after being left in the high-temperature environment is applied with the vibration, the air bubbles generated in the high-temperature environment may be removed from the gap between electrodes.

[4] For instance, the air bubbles may be generated as a result of the first battery being used. When the used battery is applied with the vibration, the air bubbles generated as a result of use may be removed from the gap between electrodes. Consequently, capacity restoration, resistance reduction, and/or the like may be achieved.

[5] The acceleration of the vibration may range from 5 G to 10 G, for example. When the acceleration of the vibration is 5 G or greater, movement of the air bubbles may be promoted. When the acceleration of the vibration is 10 G or smaller, damage to a component included in the first battery may be reduced to a negligible level.

[6] The number of times of the vibration may be 1,800,000 or greater, for example. When the number of times of the vibration is 1,800,000 or greater, movement of the air bubbles may be promoted.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a flowchart schematically illustrating the method of producing a battery according to the present embodiment.

FIG. 2 is a schematic view illustrating an example configuration of the first battery according to the present embodiment.

FIG. 3 is a schematic sectional view illustrating an example configuration of an electrode group according to the present embodiment.

FIG. 4 is a schematic view of an air bubble.

FIG. 5 is a schematic view of an example vibration exciter.

### DESCRIPTION OF THE PREFERRED EMBODIMENTS

In the following, embodiments according to the present disclosure (herein called “present embodiment”) are described. However, the description below does not limit the scope of claims. For instance, the below description about the present embodiment takes a lithium-ion battery as an example. However, the battery may have any configuration as long as it allows air bubbles to be trapped between electrodes.

### Method of Producing Battery

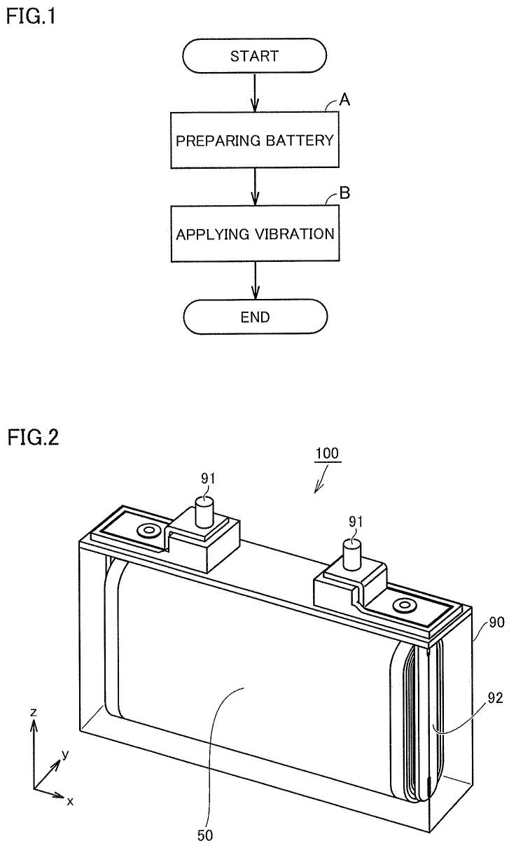

FIG. 1 is a flowchart schematically illustrating a method of producing a battery according to the present embodiment.

The method of producing a battery according to the present embodiment includes “(A) preparing a battery” and “(B) applying vibration”.

### (A) Preparing Battery

FIG. 2 is a schematic view illustrating an example configuration of a first battery according to the present embodiment.

The method of producing a battery according to the present embodiment includes preparing a first battery 100. First battery 100 according to the present embodiment refers to a battery before vibration is applied thereto.

First battery 100 is a lithium-ion battery. First battery 100 may be an unused battery. First battery 100 may be a used battery. The “used battery” according to the present embodiment refers to a battery that has a history of being mounted on an apparatus (such as an electric vehicle and/or a stationary power storage system) in actual use. The used battery may be collected from the market. The used battery may be collected from regular inspection and/or the like of an electric vehicle, for example.

First battery 100 includes a casing 90. Casing 90 is prismatic (a rectangular parallelepiped). Casing 90 is made of an aluminum (Al) alloy. However, these are merely examples. For instance, the casing may be cylindrical or the like and may be a pouch made of an aluminum-laminated film or the like.

Casing 90 is equipped with an external terminal 91. Casing 90 may be further equipped with a liquid inlet, a gas-discharge valve, and a current interrupt device (CID), for example. Casing 90 is hermetically sealed. Casing 90 accommodates an electrode group 50. To electrode group 50, a collector plate 92 is welded. Collector plate 92 electrically connects electrode group 50 and external terminal 91.

Casing 90 also accommodates an electrolyte solution (not illustrated). In other words, first battery 100 includes an electrolyte solution. The electrolyte solution according to the present embodiment contains a solvent and a lithium salt. The solvent may include a carbonate-based organic solvent, for example. The lithium salt may include LiPF₆, for example.

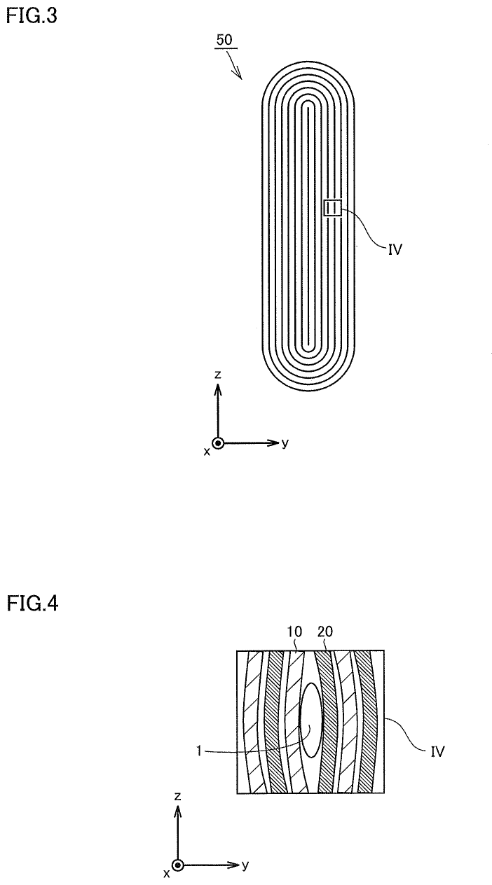

FIG. 3 is a schematic sectional view illustrating an example configuration of the electrode group according to the present embodiment.

The cross section illustrated in FIG. 3 is parallel to the y-z plane in FIG. 2. Electrode group 50 is a wound-type one. Electrode group 50 is formed by stacking a positive electrode, a separator, and a negative electrode in this order and then winding them in a spiral manner. Electrode group 50 may be formed in a flat shape.

Alternatively, the electrode group may be a stack-type one. The stack-type electrode group is formed by alternately stacking one positive electrode and one negative electrode and then repeating this alternate stacking process more than once. In each space between the positive electrode and the negative electrode, the separator is interposed.

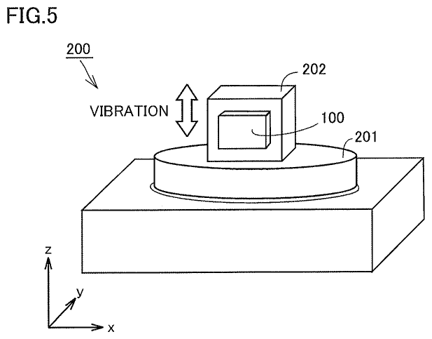

FIG. 4 is a schematic view of an air bubble.

FIG. 4 is an expanded view of a region IV illustrated in FIG. 3. For the sake of convenience, the separator is omitted in FIG. 4. Between a positive electrode 10 and a negative electrode 20, an air bubble 1 is trapped. In other words, first battery 100 includes air bubble 1 between the electrodes.

For instance, air bubble 1 may be generated as a result of, for example, degradation of an additive and/or the like contained in the electrolyte solution during initial charge and discharge in the course of production of first battery 100. In other words, air bubble 1 may be an air bubble generated during initial charge and discharge of first battery 100. When first battery 100 after initial charge and discharge is applied with vibration, air bubble 1 generated during initial charge and discharge may be removed from the gap between electrodes. For instance, vibration may be applied in 24 hours following initial charge and discharge. Removal of air bubble 1 may enhance Li-deposition resistance.

For instance, first battery 100 may be subjected to aging treatment after initial charge and discharge in the course of production of first battery 100. The aging treatment may involve, for example, leaving first battery 100 in a high-temperature environment. The high-temperature environment may be an environment having a temperature ranging from 40° C. to 80° C., for example. As a result of the aging treatment, the electrolyte solution may degrade to generate air bubble 1. In other words, air bubble 1 may be an air bubble generated as a result of first battery 100 being left in the high-temperature environment. When first battery 100 after being left in the high-temperature environment is applied with vibration, air bubble 1 generated in the high-temperature environment may be removed from the gap between electrodes. For instance, vibration may be applied in 24 hours after first battery 100 is left in the high-temperature environment. Removal of air bubble 1 may enhance Li-deposition resistance.

For instance, first battery 100 during actual use may receive load due to a combination of causes including the high-temperature environment and charge-discharge cycles. As a result, the electrolyte solution may degrade to possibly generate air bubble 1. In other words, air bubble 1 may be an air bubble generated as a result of first battery 100 being used. When the used battery is applied with vibration, air bubble 1 generated as a result of use may be removed from the gap between electrodes. Consequently, capacity restoration, resistance reduction, and/or the like may be achieved.

### (B) Applying Vibration

The method of producing a battery according to the present embodiment includes applying vibration to first battery 100 to produce a second battery. The second battery according to the present embodiment refers to a battery after vibration application.

For instance, first battery 100 may be applied with vibration in an environment at normal temperature (of 20±15° C.). In the configuration in which first battery 100 is a cell for a battery pack, vibration may be applied to first battery 100 placed under the same conditions as in a battery pack, namely, under pressure due to, for example, restraining force applied to the exterior of first battery 100. Vibration may be applied to a battery pack including first battery 100 after assembly.

FIG. 5 is a schematic view of an example vibration exciter.

For instance, a vibration exciter 200 may be employed to apply vibration to first battery 100 in a single direction. Vibration exciter 200 includes a platform 201, for example. Platform 201 is equipped with, for example, a fixing block 202 disposed thereon.

(Direction of Vibration)

First battery 100 is fixed to fixing block 202 in a manner that is suitable for the direction of the vibration. In the example illustrated in FIG. 5, vibration in the z-axis direction is applied to first battery 100. However, the direction of the vibration is not particularly limited. As long as it is applied in a single direction, the vibration may be in the x-axis direction or in the y-axis direction, for example.

(Frequency of Vibration)

The vibration has a frequency ranging from 25 Hz to 45 Hz. A frequency lower than 25 Hz may still be capable of moving air bubble 1, but moving air bubble 1 with this frequency may take a long time and therefore may be regarded as poor economy. When the frequency is higher than 45 Hz, a component included in first battery 100 may be damaged.

When first battery 100 includes a component that has a resonance frequency ranging from 25 Hz to 45 Hz, the frequency of the vibration is set so as not to overlap with the resonance frequency. This is because when this component receives a vibration having the same frequency as the resonance frequency, the component may be damaged greatly. Each component included in first battery 100 according to the present embodiment may have a resonance frequency higher than 45 Hz, for example. The frequency of the vibration according to the present embodiment may range from 25 Hz to 45 Hz (from which the resonance frequency of any of the components is excluded).

(Acceleration of Vibration)

The acceleration of the vibration may be 1 G or greater, for example. The acceleration of the vibration may be 5 G or greater, for example. With the acceleration of the vibration being 5 G or greater, movement of air bubble 1 may be promoted. The acceleration of the vibration may be 10 G or smaller, for example. With the acceleration of the vibration being 10 G or smaller, damage caused to a component included in first battery 100 may be reduced to a negligible level. The acceleration of the vibration may range from 5 G to 10 G, for example.

(Number of Times of Vibration)

The number of times of the vibration may be 360,000 or greater, for example. The greater the number of times of the vibration is, the more promoted the movement of air bubble 1 may be. The number of times of the vibration may be 1,800,000 or greater, for example. The number of times of the vibration does not have a particular upper limit to it. The number of times of the vibration may be not greater than 11,250,000, for example. It has been ensured that when the number of times of the vibration is 11,250,000, no substantial influence would be caused to battery performance and the like as long as the frequency is within the range of 25 Hz to 45 Hz. The number of times of the vibration may be not greater than 2,000,000, for example.

(Duration of Vibration)

The duration of the vibration is determined by a combination of the frequency of the vibration and the number of times of the vibration. When a vibration with a frequency of 25 Hz is applied 1,800,000 times, for instance, the duration of the vibration is 20 hours. The duration of the vibration may be 4 hours or longer, for example. The duration of the vibration may be 12.3 hours or longer, for example. The duration of the vibration may be 20 hours or shorter, for example.

Typically, various tests may be carried out after production of first battery 100 and before shipment of first battery 100. In a self-discharge test, for example, first battery 100 is left for a predetermined period of time followed by measurement of a voltage drop. A standby time may be provided after production of first battery 100 and before assembly of first battery 100 into a battery pack. A standby time may be provided after production of a battery pack and before shipment of the battery pack. The duration of the vibration according to the present embodiment may also serve as the time for the tests, the standby time, and/or the like. By doing so, the duration of the vibration is included in the time for the test and/or the like and thereby an increase in production time may be mitigated.

In this way, the second battery is produced. For instance, the second battery may have an enhanced Li-deposition resistance compared to first battery 100. For instance, the second battery may have an increased capacity compared to first battery 100. For instance, the second battery may have a reduced resistance compared to first battery 100.

### EXAMPLES

In the following, examples according to the present disclosure (herein called “present example”) are described. However, the description below does not limit the scope of claims. Each of a used battery and an unused battery of the present example is a lithium-ion battery.

### Production of battery

### Example 1

Two used batteries were prepared. These used batteries had been produced to the same specifications and used under the same conditions. Each of the used batteries included an electrolyte solution. Each of the used batteries had air bubbles between electrodes. To one of the used batteries, the vibration specified in Table 1 below was applied. The Li-deposition resistance of the used battery to which the vibration was applied was compared to the Li-deposition resistance of the other used battery to which no vibration was applied. The “Great effect observed” found in column “Evaluation” in Table 1 below means that no Li deposition was observed on the battery to which the vibration was applied and Li deposition was observed on the battery to which no vibration was applied.

### Example 2

Two unused batteries were prepared. These unused batteries had been produced to the same specifications. These unused batteries had already been subjected to initial charge and discharge. Each of the unused batteries included an electrolyte solution. Each of the unused batteries had air bubbles between electrodes. Vibration application and Li-deposition resistance evaluation were carried out in the same manner as in Example 1.

### Example 3

Vibration application and Li-deposition resistance evaluation were carried out in the same manner as in Example 1 except that the number of times of vibration was changed as specified in Table 1 below. The “Effect observed” found in column “Evaluation” in Table 1 below means that the area with Li deposition on the battery to which vibration was applied was smaller than the area with Li deposition on the battery to which no vibration was applied.

### Example 4

Vibration application and Li-deposition resistance evaluation were carried out in the same manner as in Example 2 except that the acceleration, the frequency, and the number of times of vibration were changed as specified in Table 1 below.

### Comparative Example 1

Two unused batteries were prepared. To one of these unused batteries, the ultrasonic vibration specified in Table 1 below was applied. Except this, the same manner as in Example 2 was adopted to carry out Li-deposition resistance evaluation. The “No effect observed” found in column “Evaluation” in Table 1 below means that no difference was observed in Li-deposition resistance between the battery to which vibration was applied and the battery to which no vibration was applied.

### Comparative Example 2

Ultrasonic vibration application and Li-deposition resistance evaluation were carried out in the same manner as in Comparative Example 1 except that used batteries were employed instead of unused batteries.

### Comparative Example 3

Vibration application was carried out in the same manner as in Example 2 except that the acceleration and the number of times of vibration were changed as specified in Table 1 below. In Comparative Example 3, an active material layer came off an electrode during vibration application. It may be because the frequency of the vibration was higher than 45 Hz.

### Comparative Example 4

Vibration application was carried out in the same manner as in Example 2 except that the acceleration and the number of times of vibration were changed as specified in Table 1 below. In Comparative Example 4, a weld between a collector plate and an electrode group broke during vibration application. It may be because the frequency of the vibration was higher than 45 Hz.

TABLE 1

| | | (B) Applying vibration | | | | | | | Evaluation |
|---|---|---|---|---|---|---|---|---|---|
| | (A) Preparing battery | Acceleration | Frequency | Direction | Number of times | Duration | | Note | Li-deposition resistance |
| Ex. 1 | Used batteries | 5 G | 25 Hz | Z-axis | 1,800,000 | 20 | hours | — | Great effect observed |
| | | | | direction | | | | | |
| Ex. 2 | Unused batteries | 5 G | 25 Hz | Z-axis | 1,800,000 | 20 | hours | — | Great effect observed |
| | | | | direction | | | | | |
| Ex. 3 | Used batteries | 5 G | 25 Hz | Z-axis | 360,000 | 4 | hours | — | Effect observed |
| | | | | direction | | | | | |
| Ex. 4 | Unused batteries | 10 G | 45 Hz | Z-axis | 2,000,000 | 12.3 | hours | — | Great effect observed |
| | | | | direction | | | | | |
| Comp. Ex. 1 | Unused batteries | — | 40 kHz | — | — | 300 | seconds | Ultrasonic | No effect observed |
| | | | | | | | | vibration | |
| Comp. Ex. 2 | Used batteries | — | 40 kHz | — | — | 300 | seconds | Ultrasonic | No effect observed |
| | | | | | | | | vibration | |
| Comp. Ex. 3 | Unused batteries | 20 G | 80 Hz | Z-axis | 5,000,000 | 17.4 | hours | — | Component damaged |
| | | | | direction | | | | | |
| Comp. Ex. 4 | Unused batteries | 30 G | 80 Hz | Z-axis | 800 | 10 | seconds | — | Component damaged |
| | | | | direction | | | | | |

### Results

Table 1 above illustrates that application of vibration having a frequency ranging from 25 Hz to 45 Hz to a battery may enhance Li-deposition resistance (Examples 1 to 4). It is considered that this enhancement is achieved as a result of removal of air bubbles trapped between electrodes.

When the frequency of vibration was higher than 45 Hz, a component included in the battery was damaged (Comparative Examples 3 and 4).

Ultrasonic vibration did not cause a change in Li-deposition resistance (Comparative Examples 1 and 2). Ultrasonic vibration has a very high frequency and thereby may increase damage to a component included in a battery.

The embodiments and examples disclosed herein are illustrative and non-restrictive in any respect. The technical scope indicated by the claims encompasses any modifications within the scope and meaning equivalent to the terms of the claims.

What is claimed is:

1. A method of producing a battery, comprising:
preparing a first battery including an electrolyte solution, the first battery having air bubbles between electrodes; and
applying vibration to the first battery to produce a second battery, the vibration having a frequency ranging from 25 Hz to 45 Hz.

2. The method of producing a battery according to claim 1, wherein the air bubbles are generated during initial charge and discharge of the first battery.

3. The method of producing a battery according to claim 1, wherein the air bubbles are generated as a result of the first battery being left in a high-temperature environment.

4. The method of producing a battery according to claim 1, wherein the air bubbles are generated as a result of the first battery being used.

5. The method of producing a battery according to claim 1, wherein an acceleration of the vibration ranges from 5 G to 10 G.

6. The method of producing a battery according to claim 1, wherein a number of times of the vibration is 1,800,000 or greater.
